(19) United States
(12) Patent Application Publication
(10) Pub. No.: US 2008/0217222 A1
(43) Pub. Date: Sep. 11, 2008

(54) Continuous Membrane Filter Separation of Suspended Particles in Closed Circuit

(76) Inventor: Avi Efraty, Har Adar (IL)

Correspondence Address: BROOKS KUSHMAN P.C., 1000 TOWN CENTER, TWENTY-SECOND FLOOR, SOUTHFIELD, MI, 48075, US

(21) Appl. No.: 11/995,557

(22) PCT Filed: Jul. 13, 2006
(86) PCT No.: PCT/IL06/00821

§ 371 Date: Jan. 14, 2008

(30) Foreign Application Priority Data
Jul. 13, 2005 (IL) 169654

(51) Int. Cl. B01D 21/30

(52) U.S. Cl. 210/109

(57) ABSTRACT

A modular unit apparatus for continuous separation of suspended particles from feed solutions or fluids by a consecutive sequential process in closed circuit that comprises, a closed circuit system comprising cross flow membrane filter modules having their respective inlets and outlets connected in parallel with each said module comprising a cross flow membrane filter element within housing, a circulation system enabling recycling of the feed solution or fluid through the membrane, a conducting line system for supply of said fresh feed to the closed circuit, a conducting line system for permeate collection from the membrane modules, a conducting line system for removing concentrated suspended particles solutions or fluids from the closed circuit, two valve systems for enabling connection or disconnection of said fresh feed supply line to the closed circuit, and for enabling periodic discharge suspended solution from the closed circuit without stopping filtration, and a monitoring and control systems.

### BACKGROUND OF THE INVENTION

The present invention relates to a method and apparatus for continuous membrane filter separation of suspended particles form solutions and fluids by means of a consecutive sequential process in closed circuit without containers.

The application of closed-loop (close circuit) re-circulation to the separation of suspended particles from solutions or fluids was first proposed by Szucz et al. in the U.S. Pat. No. 4,983,301 entitled “Methods and apparatus for treating Fluids Containing Foreign materials by Membrane Filer equipment”, wherein, said foreign materials are either suspended particles or dissolved salts. This patent, with its extensive theoretical description, claimed apparatus and method for non-continuous (batch) filtration, and/or desalination, in closed loop (closed circuit) as well as the making of such an equipment operate continuously by means of “ . . . two vessels which are arranged in the fluid circuit and adapted to be switched over.”. The closed circuit approach to filtration has not gained much attention over the years, since modern filtration techniques normally require continuous processes and the making of the inventive process continuous required the application of large container vessels and other means in order to enable their alternating engagement in the process.

The present invention describes simple apparatus and method, whereby continuous filtration, up to the level of nano filtration, can be performed continuously and effectively by means of a consecutive sequential process without any need for container vessels

### SUMMARY OF THE INVENTION

The present invention proposes an apparatus and method for continuous separation of suspended particles from solution or fluids using a consecutive sequential process; wherein, feed is recycled in closed circuit through parallel modules with cross flow membrane filters, and with entire process driven continuously by means of pressurized feed, or instead by means of permeate suction, with released permeate replaced continuously by fresh feed and enriched suspended particles solution discharged periodically from said closed circuit at a desired filtration recovery level, while said filtration process is continued non-stop.

During suspended particles separation in closed circuit according to the present invention, the concentration of suspended particles at module(s) inlet(s) is kept lower than that at module(s) outlet(s) due to mixing with fresh feed, and this dilution effect implies lower exposure of membrane filter surfaces to the cross flow of particulate matter as compared with “dead end” filtration techniques.

The inventive method of continuous cross flow filtration in closed circuit by a consecutive sequential process is a modular technology of simple design, made of readily available commercial components and parts that should allow cost effective filtration (micro-filtration, ultra-filtration, nano-filtration, etc.) in small, medium and large scale apparatus assembled from the same basic modular units.

### BRIEF DESCRIPTION OF DRAWINGS

FIG. 1A is a schematic diagram of a modular unit with five cross flow membrane filter modules according to the preferred embodiment of the invention that is engaged in closed circuit filtration by a consecutive sequential process.

FIG. 1B is a schematic diagram of a modular unit with five cross flow membrane filter modules according to the preferred embodiment of the invention that is engaged in the replacement of suspended particles solution form closed circuit by fresh feed while filtration by a consecutive sequential process is continued.

FIG. 1C is a schematic diagram of a modular unit with five cross flow membrane filter modules according to the preferred embodiment of the invention that is engaged in membrane filters backwash while filtration is completely stopped.

FIG. 2A is a schematic diagram according to the preferred embodiment of the invention of an apparatus for continuous filtration made of five modular units of the design depicted in FIG. 1(A, B and C) with its feed pressurizing system, backwash pressuring system and conducting lines for pressurized feed, permeate collection and discharge of suspended particles solution, while engaged in continuous filtration under positive pressure.

FIG. 2B is a schematic diagram according to the preferred embodiment of the invention of an apparatus for continuous filtration made of five modular units of the design depicted in FIG. 1(A, B and C) with its feed pressurizing system, backwash pressurizing system and conducting lines for pressurized feed, permeate collection, discharge of suspended particle solution and membrane filter backwash, while filtration is stopped and a membrane filter cleaning process (CIP) is taking place instead.

FIG. 3A is a schematic diagram according to the preferred embodiment of the invention of an apparatus for continuous filtration made of five modular units of the design depicted in FIG. 1(A, B and C) with its permeate suction system, backwash pressurizing system and conducting lines for feed, permeate collection, discharge of suspended particles solution and membrane filters backwash, while engaged in continuous filtration under at atmospheric pressure.

FIG. 3B is a schematic diagram according to the preferred embodiment of the invention of an apparatus for continuous filtration made of five modular units of the design depicted in FIG. 1(A, B and C) with its permeate suction system, backwash pressurizing system and conducting lines for feed, permeate collection, discharge of suspended particles solution and membrane filter backwash, while filtration is stopped and a membrane filter cleaning process (CIP) is taking place instead.

FIG. 4 is a graphic description of simulated results received for the continuous membrane filtration in the apparatus of the preferred embodiment displayed in FIG. 2; wherein, modular units are of the preferred embodiment displayed in FIG. 1; showing variations of suspended particles concentrations at membrane filter modules inlets and outlets on the time scale (FIG. 4A) and the recovery scale (FIG. 4B) of the exemplified closed circuit filtration; whereby 98% recovery corresponds to a consecutive sequential filtration process of 20 minutes, starting with solution containing 10 ppm of particulate matter.

### DETAILED DESCRIPTION OF THE INVENTION

The inventive apparatus and method for continuous consecutive sequential filtration in closed circuit provide a uniformed approach to the separation of suspended particles from solutions or fluids by simple means using cross flow membrane filter modules. This approach may apply to Micro-Filtration (MF), Ultra-Filtration (UF), Nano-Filtration (NF) as well as to the separation of particulate matter of larger dimensions. According to the inventive method, feed solution is continuously admitted to a closed circuit with modules of cross flow membrane filters, wherein, said feed solution is recycled to the desired recovery level, then the suspended particles solution discharged to the outside, and thereafter, this two step process is repeated in a consecutive sequential manner. Filtration by the inventive method can be driven by pressurized feed, or alternatively, by permeate suction.

Recycling in closed circuit according to the inventive method creates a strong dilution effect, since module outlet is mixed with fresh feed before recycled, as well as a strong cross flow vector component that effects the retention of particulate matter in the moving bulk flow away from membrane filter surfaces. The dilution effect relates to the rate flow of permeate as well as to recycling rate flow; whereas, the cross flow effect is mainly a function of the rate flow created by the circulation device in the closed circuit. The combining of said dilution and cross flow effects by the inventive method should results in relatively low suspended particles concentrations on membrane filter surfaces even at high filtration recovery, therefore, enable long intervals between subsequent membrane cleaning modes by the “so-called” Clean in Place (CIP) procedure.

The consecutive sequential process offered by the inventive apparatus and method allow continuous filtration of high recovery with each new sequence initiated with a fresh feed supply of relatively low suspended particles concentration. Accordingly, the frequent initiation of new filtration cycles with fresh feed, combined with said dilution and cross flow effects, would facilitate the maintaining clean membrane filter surfaces over long periods of time, thereby, decrease the tendency of membrane pores clogging by particulate matter. Increased membrane filter surface cleanliness by the inventive apparatus and method implies faster permeate flow over longer periods and CIP procedures performed at lesser frequency as compared with existing filtration methods that proceed not via a closed circuit system.

It is another advantage of the inventive apparatus and method that modular filtration units can be combined to any desired filtration capacity plant, wherein, feed pressurizing means, or permeate suction means instead, are provided centrally. The modularity of the inventive method is with respect to the design of modular units as well as with respect to the design of full scale apparatus of large production capacity made of many modular units of desired configuration.

The inventive apparatus and method eliminate the needs for bulky tanks and/or containers such that are currently required in the context of the immersed membranes filtration technology, and this without restricting the size nor the capacity of the filtration apparatus or plant.

The inventive apparatus and method provide means to enable membrane filter cleaning by pressurized backwash of permeate and/or of any other cleaning solution or fluid of choice. Membrane filter cleaning by pressurized backwash can be performed only when the closed-circuit filtration process is stopped.

The inventive apparatus and method do not restrict the application of common feed pretreatment practices, nor precludes the implementation of other noteworthy prevailing practices such as the use of compressed air to facilitate the membrane filter cleaning process.

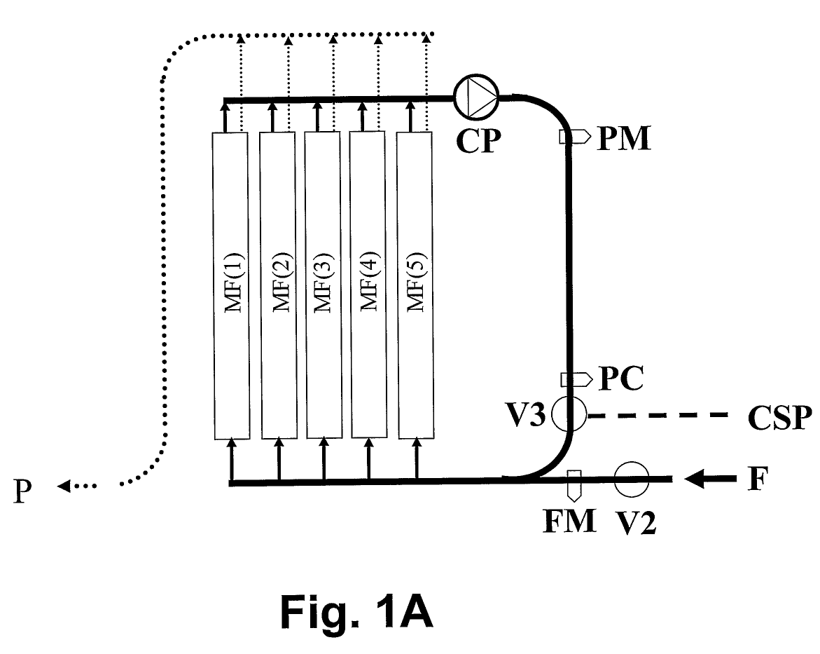

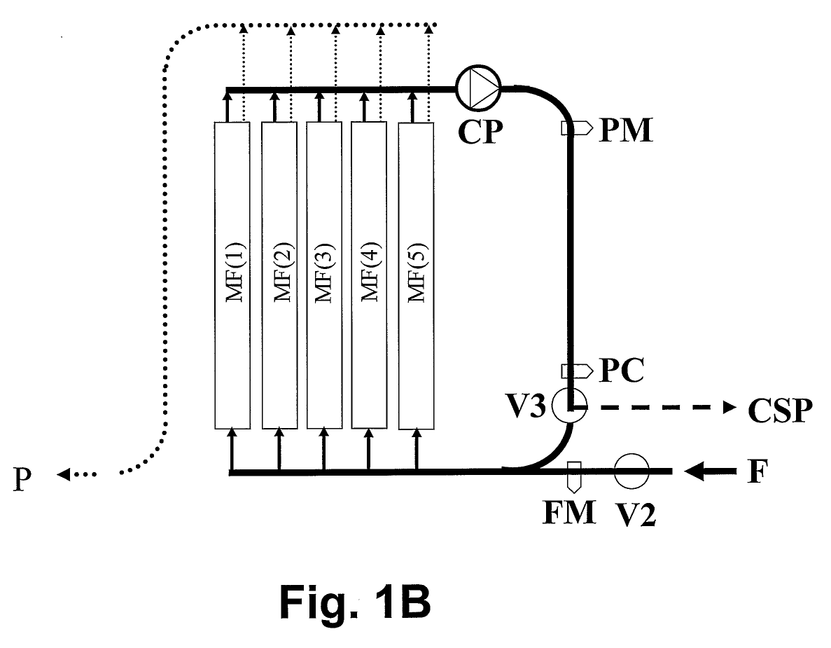

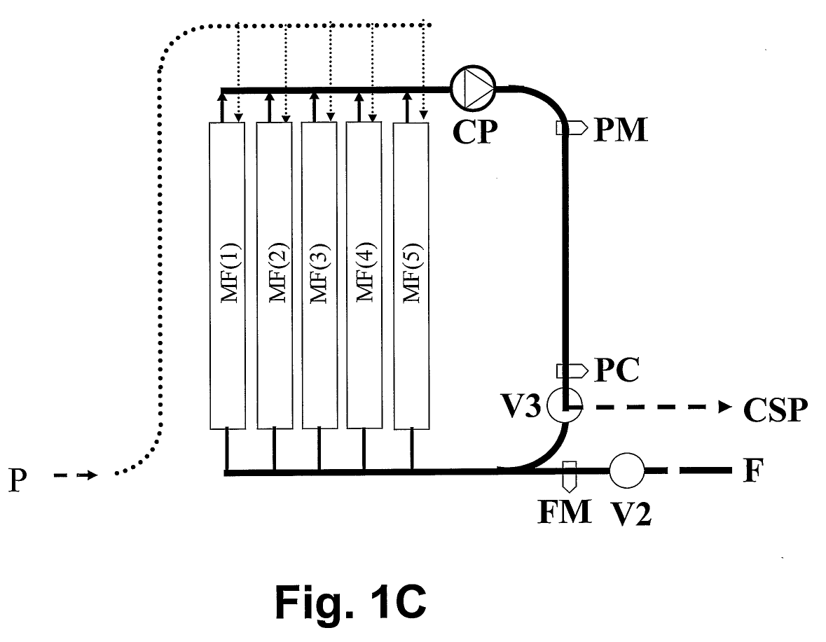

The preferred embodiment of the inventive membrane filter modular unit in FIG. 1(A and B) comprises: a closed-circuit system with 5 membrane filter modules (MF(1), MF(2), MF(3), MF(4) and MF(5)) having their respective inlets and outlets connected in parallel by conducing lines; a circulation pump (CP), a conducting line for fresh feed intake (F), a conducting line for the discharge of concentrated suspended particles solution (CSP), conducting lines for permeate collection (P), a two-way valve device (V2), a three-way valve device(V3), a monitoring counter device of particulate matter (PC), a flow and volume monitoring device (FM) and a pressure monitoring device (PM).

In FIG. 1A, the conducting lines for fresh feed, mixed with recycled suspended particles solution or not, are indicated by solid lines; the conducting line for the discharge of concentrated suspended particle solution by a dashed line and the conducting lines for permeate collection by dotted lines. The directions of flow in the various lines are indicated by arrows. The intrinsic volume of the closed circuit is derived form the volume of suspended particles solution contained in the membrane filter modules and the conducting lines of said closed circuit.

The configuration depicted in FIG. 1A is that of membrane filtration with closed circuit recycling while fresh feed is continuously admitted to the system in replacement of released permeate, a mode experienced most of the time when this inventive modular unit is being actuated. The configuration depicted in FIG. 1B is that of membrane filtration with simultaneous replacement of the concentrated suspended particles solution in the closed circuit with fresh feed, a mode experienced only small part of the time when this inventive modular unit is being actuated. The configuration depicted in FIG. 1C is that of membrane filters backwash with pressurized permeate, a process which may take place only when filtration is stopped, as revealed by the closure of feed inlet valve V2.

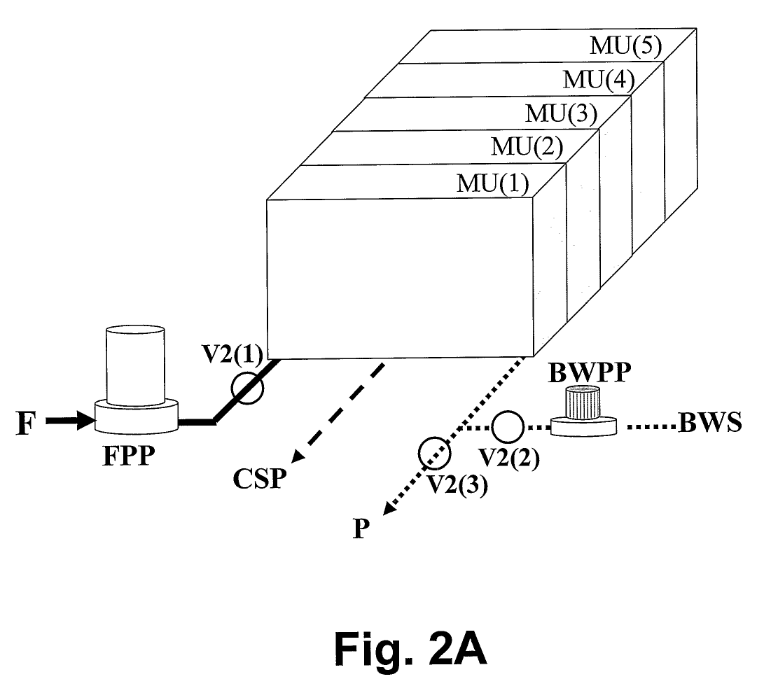

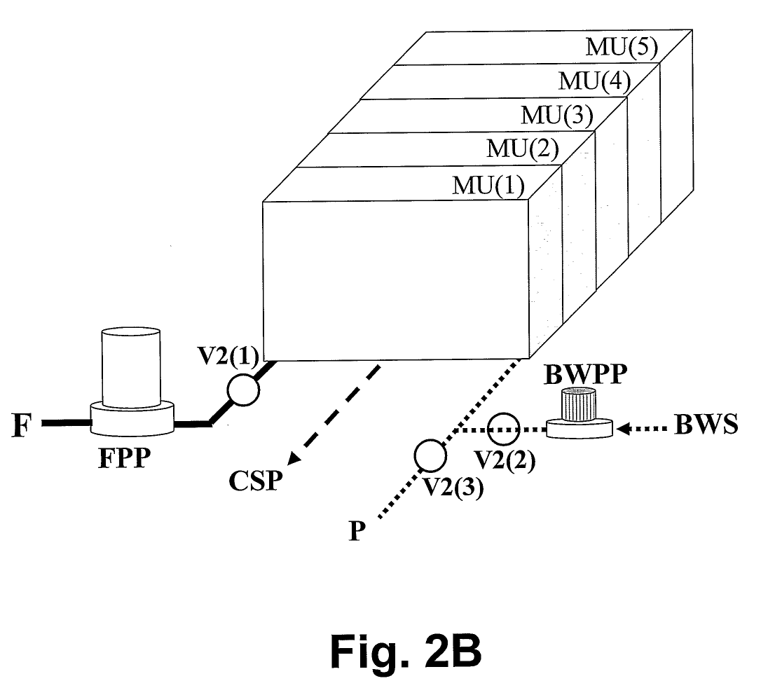

The filtration apparatus of the inventive method comprises one or more modular units of the preferred embodiment displayed in FIG. 1 with conductive lines and central systems that service all the modular units in the apparatus. The apparatus of the preferred embodiment displayed in FIG. 2(A and B) comprises; five modular units [MU(1), MU(2), MU(3), MU(4) and MU(5)] of the design depicted in FIG. 1 with their respective inlets for fresh feed centrally supplied with pressurized feed by means of the feed pressurizing pump FPP; their respective outlets of concentrated suspended particles connected to the central drain line CSP; and their respective outlets of release permeate connected to the central permeate collection line P. The filtration apparatus displayed in FIG. 2(A and B) also contains the backwash pressurizing pump BWPP; the backwash solution inlet BWS; and the two-way valves V2(1), V2(2) and V2(3). During the continuous filtration mode of the apparatus displayed in FIG. 2A, the valves V2(1) and V2(3) are kept open whereas V2(2) is closed. During the membrane filter backwash mode of operation displayed in FIG. 2B, the backwash pump BWS is actuated, valve V2(2) is open, whereas valves V2(1) and V2(3) are kept closed.

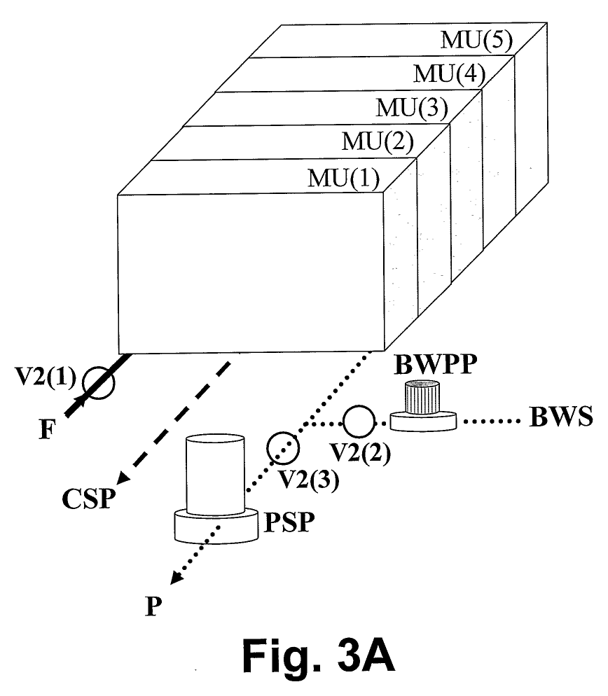

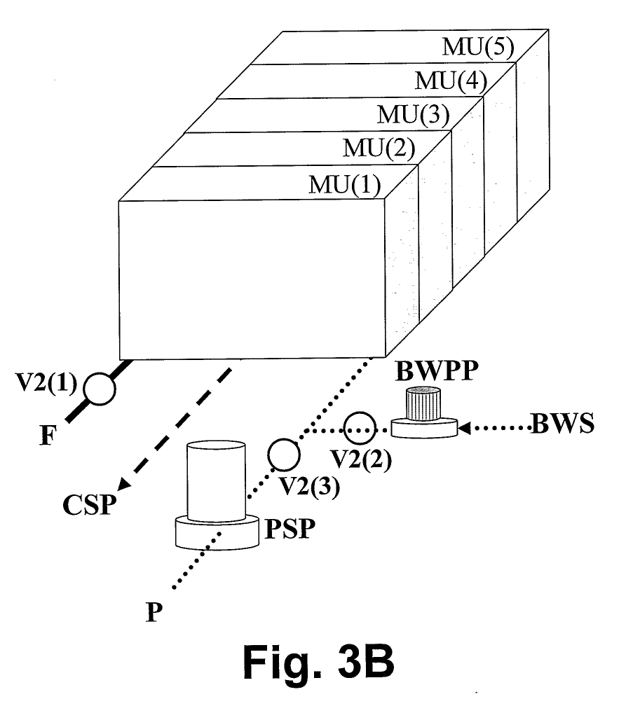

The apparatus of the preferred embodiment displayed in FIG. 3(A and B) comprises five modular units [MU(1), MU(2), MU(3), MU(4) and MU(5)] of the design depicted in FIG. 1 with their respective inlets for fresh feed centrally supplied by means of the non-pressurized feed line F; their respective outlets of concentrated suspended particles connected to the central drain line CSP; and their respective permeate release outlets connected to the central permeate collection line P that is driven by the Permeate Suction Pump PSP. The filtration apparatus displayed in FIG. 3 (A and B) also contains the backwash pressurizing pump BWPP; the backwash solution inlet BWS; and the two-way valves V2(1), V2(2) and V2(3). During the continuous filtration mode of the apparatus displayed in FIG. 3A, the valves V2(1) and V2(3) are kept open, whereas V2(2) is closed. During the membrane filter backwash mode of operation displayed in FIG. 3B, the backwash pump BWS is actuated, valve V2(2) is kept open, whereas valves V2(1) and V2(3) are closed.

Membrane filtrations in the apparatus of the preferred embodiments displayed in FIG. 2(A and B) or FIG. 3(A and B) are controlled through their modular units of the preferred embodiment depicted in FIG. 1(A, B and C). The steps of the consecutive sequential filtration process in each of the modular units are initiated and terminated by signals form the PC and/or from the VM that manifest the attainment of the desired recovery and/or the completion of CSP discharge while the closed circuit is being recharged with fresh feed. A precise control of the consecutive sequential process in the modular units of the preferred embodiment [FIG. 1(A and B)] can be achieved by the actuation of V3 in response to signals form the PC; with a high predefined particles count signal that manifests the attainment of the desired recovery causing CSP discharge (FIG. 1A); and with a low predefined particles count that manifests the complete recharge of the closed circuit with fresh feed causing the resumption of recycling (FIG. 1B). The volume and flow meter device VM in FIG. 1(A and B) provides data pertaining to released permeate or supplied fresh feed that can also be used for the control of the consecutive sequential filtration process in the modular units. Approximate control of the consecutive sequential process in the modular units can be achieved by means of a timer provided that the durations of the recycling and CSP discharge modes are known with good accuracy,

Each modular unit of the referred embodiment in FIG. 1(A and B) is linked to the central feed supply line of the modular filtration apparatus of the inventive method through the valve V2, and therefore, each unit can be disconnected temporarily for maintenance and/or repairs while membrane filtration is continued in the remaining modular units of the apparatus. Noteworthy is that the V2 valves in all of the modular units of the preferred, embodiments displayed FIG. 1C are kept closed during the membrane filter cleaning in place (CIP) procedure of the modular apparatus with the preferred embodiments displayed in FIG. 2B and 3B.

It will be understood that the design of the membrane filter modular units and apparatus shown in FIG. 1(A, B and C), FIG. 2(A and B) and FIG. 3(A and B) are schematic and simplified and are not to be regarded as limiting the invention. In practice, the membrane filter modular units and apparatus according to the invention may comprise many additional lines, branches, valves, and other systems and devices as deemed necessary according to specific requirements, while still remaining within the scope of the inventions and claims.

All the preferred embodiments displayed in FIG. 1-3 comprise membrane filter modular units with 5 membrane filter modules and modular apparatus made of 5 such modular units, and this for the purpose of simplicity, clarity, uniformity and the convenience of presentation. It will be understood that modular membrane filter units according to the invention are not confined to 5 membrane filter (MF) modules and may comprise any desired number (m) of such modules [MF(1), MF(2), MF(3) . . . MF(m)]. It will also be understood that modular apparatus according to the invention are not confined to 5 modular membrane filter units (MU) and may comprise any desired number (n) of such modular units [MU(1), MU(2), MU(3) . . . MU(n)]. Accordingly, modular units of any desired number of membrane filter modules and modular apparatus of any desired number of said modular units are within the framework and scope of the inventive apparatus and method.

It will be understood that the feed pressurizing pump (FPP) in the preferred embodiment of the modular filtration apparatus displayed in FIG. 2 may comprise a single such pump, or of several such pumps that are actuated simultaneously or alternately in parallel. It will also be understood that the permeate suction pump (PSP) in the preferred embodiment of the modular filtration apparatus displayed in FIG. 3 may comprise of a single such pump, or of several such pumps that are actuated simultaneously or alternately in parallel. The backwash pressurizing pump (BWPP) according to the preferred embodiments displayed in FIG. 2 or FIG. 3 may comprise of a single such pump, or of several such pumps that are actuated simultaneously or alternately in parallel. The circulating device in the preferred embodiment of the modular filtration units displayed in FIG. 1 may comprise of a single circulation pump or of several such pumps that are actuated simultaneously or alternately in parallel and/or in line, with fixed or variable flow rate as deemed necessary.

### EXAMPLE

An aqueous solution with suspended particles concentration (SPC) of 10 mg/liter (10 ppm) of maximum particulate matter dimensions greater than the pore size of Micro-Filter membrane, is fed to the apparatus exemplified schematically in FIG. 2 with 5 modular units of the schematic design in FIG. 1. A typical cross flow membrane filter module in this apparatus comprises 50 m² of membrane filter surfaces and is presumed to yield an average permeate flux of 75 l/m²/h under pressure of 2.5 bar. The average filtration flow rate of the entire apparatus is, therefore, 93.75 m³/h or 2,250 m³/day.

The presumed dimensions of a cylindrical module are 20×200 cm (diameter-length), the estimate dimensions of said modular unit are 50×250×200 cm (width-length-height) and the estimated ground space of an apparatus with 5 such units is under 10 m².

The intrinsic closed circuit volume per said modular unit is presumed 125 liter and said circulation pump (CP) of such unit is of presumed recycling flow rate of 20.0 m³/h at pressure difference of ˜0.5 bar. The average pressurized (2.5 bar) feed supply by FPP to said apparatus of 5 modular units is 92.5 m³/h (1,543 liter/minute). The combined average power demand of said pumps, actuated with presumed efficiency of 70%, during continuous filtration operation is 11.2 kW with specific energy demand of 0.122 kWh per cubic meter permeate.

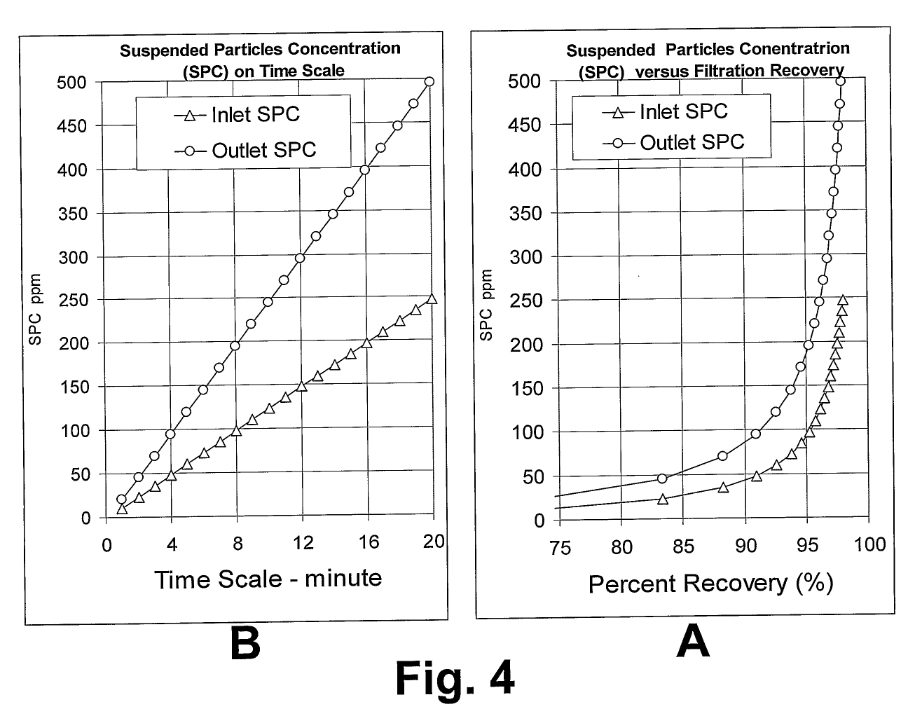

The simulated results of continuous filtration in the exemplified inventive apparatus are described graphically in FIG. 4 with respect to a consecutive sequential filtration process with recycling steps of 20 minute in closed circuit and with discharge steps of concentrated suspended particles solution of 22.5 second (0.375 minute). Accordingly, each of the modular units in said apparatus performs consecutively two step cycles of 20.375 minute with 98% recovery during the continuous filtration process. The graphic results displayed in FIG. 4 pertain to modules inlets and outlets concentrations of the recycled suspended particles solutions expressed on the recovery scale (FIG. 4A) and on the time scale (FIG. 4B) of the exemplified continuous consecutive sequential filtration process. The exemplified results in FIG. 4 illustrate the strong dilution effect that typifies the closed circuit filtration process in the inventive apparatus.

Membrane filter backwash cleaning in the exemplified apparatus should be warranted when permeate flow under specified pressure drops below a predetermined level. Prior to membrane filters backwash, filtration is stopped, appropriate valves in modular units and apparatus switched to CIP configuration, and then backwash pumps actuated for the desired duration causing pressurizing backwash cleaning solution of choice through membrane pores from inside out, thereby, forcing the clogging particles out of the membrane pores. After CIP completed, backwash pump is turned off and the appropriate valves in the modular units and the apparatus switched back to the normal configuration to enable resumption of continuous filtration in closed circuit. If backwash solution is other than permeate, the initial fraction of permeate produced after CIP should be discharged.

1. A modular unit of an apparatus for continuous separation of suspended particles from feed solutions or fluids by a consecutive sequential process in closed circuit that comprises:
at least one closed circuit system comprising one or more cross flow membrane filter modules having their respective inlets and outlets connected in parallel by conducting lines with each said module comprising at least one cross flow membrane filter element within housing;
at least one circulation system to enable recycling of said feed solution or fluid through said one or more membrane filter modules of said closed circuit;
at least one conducting line system for supply of said fresh feed to said closed circuit;
at least one conducting line system for permeate collection from said one or more membrane filter modules of said closed circuit;
at least one conducting line system for removing concentrated suspended particles solutions or fluids from said closed circuit;
at least one valve system to enable connection or disconnection of said fresh feed supply line to said closed circuit;
at least one valve system to enable periodic discharge of concentrated suspended particles solution or fluid from said closed circuit and its recharge with fresh feed without stopping filtration; and
monitoring and control systems to enable continuous cross flow membrane filter separation of suspended particles from said feed solutions or fluids by said consecutive sequential process in closed circuit.

2. A modular unit of an apparatus for continuous separation of suspended particles from feed solutions or fluids according to claim 1;
wherein, said circulation system comprises, one or more than one, circulation pump,
wherein, said monitoring and control systems comprise, one or more than one, unit of the following devices; counters of suspended particles in solutions or fluids, volume and flow meters, pressure monitors, and actuators of said valve systems whereby said modular unit could be engaged continuously in said consecutive sequential filtration process of a predetermined desired recovery.

3. An apparatus for continuous separation of suspended particles from feed solutions or fluids by a consecutive sequential closed circuit process driven by pressurized feed that comprises:
one or more modular units according to claim 1, each containing one or more cross flow membrane filter modules;
a pressurizing system for said feed with one pressurizing pump or more, whereby said process is being driven;
conducting lines whereby said pressurized feed is being delivered to said modular units;
conducting lines for collecting permeates released form said modular units;
conducting lines for discharging concentrated suspended particles solutions or fluids from said modular units; and
a valve system for periodic discharge of concentrated suspended particles solution or fluid from said closed circuit and its recharge with fresh feed without stopping filtration, operated by means of an actuator in response to signals received from said counter of particles with initiation of said periodic discharge taking place at a predefined level of increased concentration of suspended particles and with termination of said periodic discharge and resumption of closed circuit filtration taking place when suspended particles level manifests complete recharge of said closed circuit with fresh feed.

4. An apparatus for continuous separation of suspended particles from feed solutions or fluids by a consecutive sequential closed circuit process driven by permeate suction that comprises:
one or more modular units according to claim 1, each containing one or more cross flow membrane filter modules;
a suction system for said permeate with one suction pump or more, whereby said process is being driven;
conducting lines whereby non-pressurized said feed is being delivered to said modular units;
conducting lines for collecting permeates released by suction form said modular units;
conducting lines for discharging concentrated suspended particles solutions and fluids from said modular units; and
a valve system for periodic discharge of concentrated suspended particles solution or fluid from said closed circuit and its recharge with fresh feed without stopping filtration, operated by means of an actuator in response to signals received from said counter of particles with initiation of said periodic discharge taking place at a predefined level of increased concentration of suspended particles and with termination of said periodic discharge and resumption of closed circuit filtration taking place when suspended particles level manifests complete recharge of said closed circuit with fresh feed.

5. A modular unit of claim 1 with pressurized feed or with permeate suction instead, for the separation of suspended particles from solutions and fluids including at the level of micro-filtration, ultra-filtration and nano-filtration.
